(19) United States
(12) Patent Application Publication
(10) Pub. No.: US 2007/0034149 A1
(43) Pub. Date: Feb. 15, 2007

(54) Toilet paper roll holder

(76) Inventor: Miguel Gonzalez Escobar, Arenys De Mar (ES)

Correspondence Address: WOLF, BLOCK, SHORR AND SOLIS-COHEN LLP, 250 PARK AVENUE, 10TH FLOOR, NEW YORK, NY, 10177, US

(21) Appl. No.: 10/575,306

(22) PCT Filed: Oct. 6, 2004
(86) PCT No.: PCT/IB04/03255

§ 371 Date: Apr. 11, 2006

(30) Foreign Application Priority Data
Oct. 17, 2003 (ES) U-200302356

(51) Int. Cl. B05C 5/00

(52) U.S. Cl. 118/325; 242/905

(57) ABSTRACT

It comprises a casing (1) which includes means for supporting the toilet paper roll (4) and means for supplying a liquid for dampening said paper. It is characterized in that said means for supplying a liquid consist essentially of a dosing element (5) partially closed of replaceable or rechargeable type which is snapped into the casing (1).

### OBJECT OF THE INVENTION

The aim of the present application is the registration of a toilet paper roll holder which incorporates notable innovations and advantages against other roll holders present in the market.

More specifically, it refers to a toilet paper roll holder comprising a casing which includes means for supplying the toilet paper and means for supplying a liquid for dampening the paper, if desired, with water or any other liquid for personal hygiene or perfumed.

### BACKGROUND OF THE INVENTION

Currently, it is known in the state of the art a toilet paper roll holder for its use for either dry or wet paper which allows adding a liquid substance to the toilet paper. Said roll holder is described in the Spanish Utility Model n^{o} U 200102568.

In said document, reference is made to a toilet paper roll holder which is made of a casing of preferably plastic material whose recipient-like interior can be filled with water or other treatment or cleaning liquid, perfumed or not. Over it, and without being in contact, there is a toilet paper roll holder whose paper sheet is forced to pass through a fork which holds it and separates it from being in contact with the liquid of the recipient.

However, the device described before has the disadvantage that it is not very hygienic, as the fact of having an open-type recipient causes the liquid contained therein to get easily dirty with dust or any other substance close to it as, for example, an insect, or even existing the possibility that children can access directly to the liquid, bearing in mind its toxicity in case of ingestion, or when the contact with the liquid has occurred, causing the appearance of germens which subsequently could come into contact with personal parts of the user.

On the other hand, in the case of using an aromatic substance, that is, a volatile-type substance, it can easily evaporate in a short period of time. This causes that the recipient containing the aromatic liquid has to be filled more frequently.

### DESCRIPTION OF THE INVENTION

The present invention has been developed with the aim of providing a toilet paper roll holder which solves the aforesaid mentioned disadvantages, also providing other additional advantages which will be evident in view of the description set out below.

The toilet paper roll holder, of the type comprising a casing which includes means for supporting the toilet paper roll and means for supplying a liquid for dampening said paper, is characterized in that said means for supplying a liquid consist essentially of a dosing element partially closed of replaceable or rechargeable type which is snapped into the casing.

Thanks to these characteristics, an easy-to-manufacture roll holder is provided which includes a dosing element which provides a usually liquid aromatic or hygienic type substance over one of the surfaces of hygienic paper. Said dosing element is easily replaced when it is empty. Moreover, the dosed liquid or substance is hidden and protected from the outside, thus avoiding manipulation of said substance, unlike what it happens with the aforesaid described antecedents.

The application of the dosed substance is quite easy and hygienic, and it can be optional, that is, there is the possibility of choosing dry or wet paper according to the necessities of the user. Said application is carried out by manually pushing downwards the dosing element, the liquid substance flowing out, for example, through a plurality of small orifices which spread the liquid in the toilet paper and, once the unloading has been carried out, it returns to its initial position.

According to another aspect of the present invention, the roll holder comprises a housing located in the upper part that allows placing the dosing element. Said housing allows placing and removing the dosing element rapidly.

Advantageously, the dosing element comprises a plurality of orifices for the distribution of the liquid on the paper. Thus, the liquid is distributed effectively over the paper pushing over the dosing element.

Preferably, the casing comprises stop means to prevent the toilet paper roll from revolving continuously and involuntarily, what would mean an unnecessary waste of paper.

For their part, said means allow to choose the selected amount of wet or dry paper thanks to the braking, as it is only necessary a simple pushing of the dosing element and the subsequent cutting of the paper.

According to an embodiment of the invention, the stop means consist of a device formed by a pin which includes an elastic spring or similar.

According to another aspect of the invention, the casing comprises a hinged retractable lid located in the lower part of the housing for the dosing element which includes guide means for the path of the toilet paper. The presence of said lid is essential to prevent the contact or manipulation before use, being it indispensable to collect the remaining liquid, in the case it would exist.

Advantageously, the casing includes a serrated portion to facilitate the cutting of the toilet paper, the sides of the paper being protected to prevent involuntary friction cuttings.

Preferably, the casing of the roll holder has a folding lid in its upper part which facilitates the access to the paper roll and for the extraction of the dosing element, said lid including a recess to facilitate its manipulation.

Further characteristics and advantages of the toilet paper roll holder object of the present invention will become evident from the description of a preferred but non-exclusive embodiment, which is illustrated by way of non-limitative example in the accompanying drawings, wherein:

### BRIEF DESCRIPTION OF THE DRAWINGS

FIG. 1.—Is a perspective view of a toilet paper roll holder of the present invention with a toilet paper roll placed therein and;

FIG. 2.—Is a section elevational side view of the casing of the roll holder represented in the previous figure, with the lid in lower position;

FIG. 3.—Is a perspective detail view of the lid of the roll holder;

FIG. 4.—Is a perspective view of the roll holder with the lid in a low position which shows the lower part of the housing of the dosing element.

### DESCRIPTION OF A PREFERRED EMBODIMENT

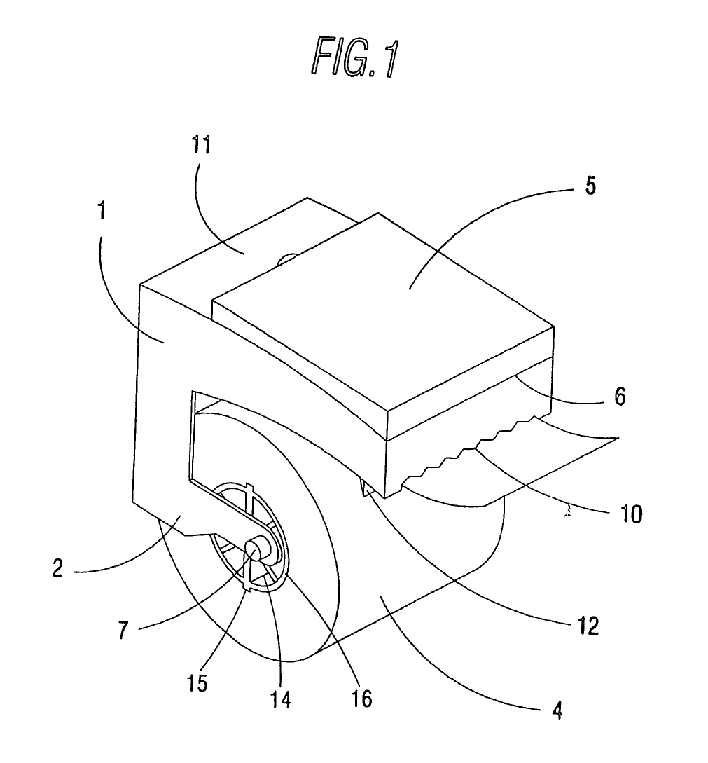

As shown in FIG. 1, the toilet paper roll holder of the present invention comprises a casing (1) which is made up of two lower separated wings (2), (3) that support the axle (16) of the paper roll (4).

The roll holder also has means for supplying a, for example, liquid substance, with or without perfuming, which consist essentially of a partially closed dosing element (5) of replaceable or rechargeable-type which is snapped into the casing (1). The casing (1) comprises a housing (6) located on the upper part to house said dosing element (5).

As it can be seen, the lower wings (2), (3) of the casing (1) comprise stop means, like brakes, to prevent the toilet roll paper (4) from revolving involuntarily.

Said stop means of the roll holder of the present invention consist of a device made up of a pin (7) which includes an elastic spring (not represented) or similar element. The device also includes a pair of slots (15) in the roll (4) in which there are housed radial ribs (14) of the axle (16) of the roll holder.

The pin (7), once pushed, allows blocking the revolving movement of the roll (4) at one's discretion, being inserted between the ribs (14) of the axle (16) and preventing the roll (4) from revolving when the content of the liquid is applied over the paper or when it is pulled.

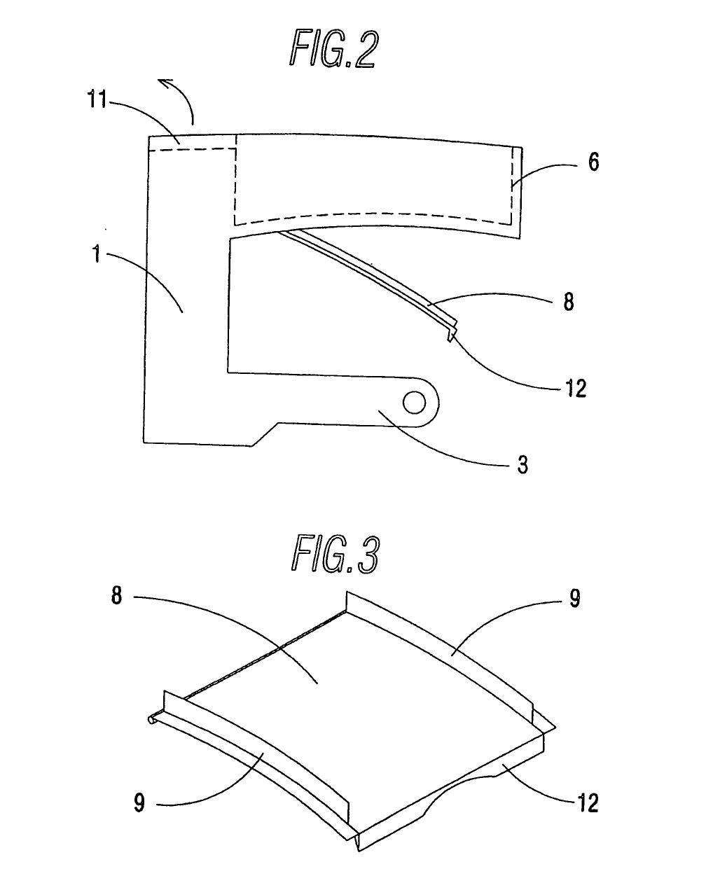

FIG. 2 shows the casing (1) comprising a hinged retractable lid (8) located on the upper part of the housing (6) open by its lower part and for the dosing element (5). The lid (8) includes guide means (see FIG. 3) formed by a pair of longitudinal guides (9) which facilitate positioning the paper and prevents the contact and manipulation before using it. When the paper is over this lid (8) the content of the dosing element (5) is applied over it.

The casing (1) includes in the front part a serrated portion (10) to facilitate the cutting of the toilet paper and with its sides protected.

The lid (8) also includes a flange (12) in its front part which has a central recess to facilitate the manual extraction of the toilet paper.

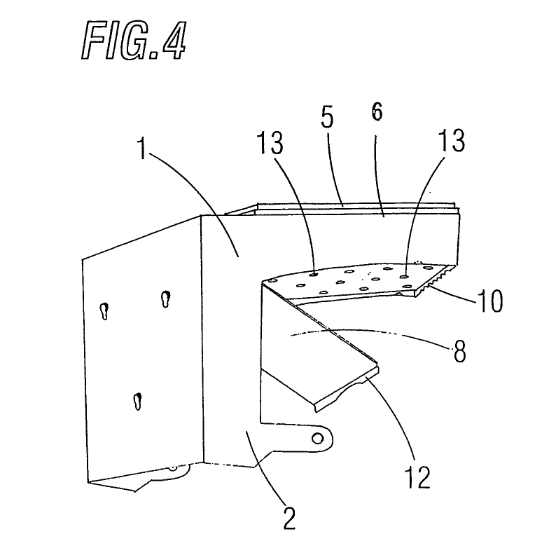

In FIG. 4 it can be seen a perspective view of the lid (8) open that shows the lower part of the dosing element (5), which has a plurality of orifices (13) for distributing the liquid or product contained in said dosing element (5) over the paper. The paper slides over the lid (8) before it goes out.

On the other hand, the casing (1) has in its upper part (FIG. 2) a folding lid (11), whose angular movement has been represented by an arrow. As it can be seen in FIG. 1, the free end of the lid (8) does not reach the end of the casing (1), forming a free space of between 2 and 4 cm. approximately, so that the paper hangs slightly over the flange (12) and the grabbing of the toilet paper is facilitated.

From what has been set out above, it may be deduced that the roll holder of the invention allows choosing between the use of dry or wet toilet paper in an easy and effective way. For supplying liquid to the paper, it is only necessary a simple pushing of the dosing element (5), staying its content out of the reach of people and perfectly insulated from the outside, the body occupying much less space that the known devices.

The details, the shapes, the dimensions and other optional elements, as much as the materials used to make the toilet paper roll holder of the invention may be conveniently substituted by other technically equivalent and that do not go out of the essentiality of the invention nor the field defined by the claims which are included below.

1. Toilet paper roll holder, comprising a casing (1) which includes means for supporting the toilet paper roll (4) and means for supplying a liquid for dampening said paper, said means for supplying a liquid consisting essentially of a dosing element (5) partially closed of a replaceable or rechargeable type which is snapped into the casing (1), wherein the casing (1) comprises stop means (7, 14, 15) for blocking the revolving movement of the toilet paper roll (4), said stop means consisting of a device formed by a pin (7), which includes an elastic spring, which is introduced between ribs (14) of an axle (16) for supporting the roll (4).

2. Toilet paper roll holder, according to claim 1, wherein the casing (1) comprises a housing (6) located in the upper part of the roll holder that allows placing the dosing element (5).

3. Toilet paper roll holder, according to claim 2, wherein the dosing element (5) comprises a plurality of orifices (13) for the distribution of the liquid in the paper.

4. Toilet paper roll holder, according to claim 1, wherein the casing (1) comprises a hinged retractable lid (8) located in the lower part of the housing for the dosing element which includes guide means (9) for the path of the toilet paper.

5. Toilet paper roll holder, according to claim 1, wherein the casing (1) includes a serrated portion (10) to facilitate the cutting of the toilet paper (4).

6. Toilet paper roll holder, according to claim 1, wherein the casing (1) has a folding lid (11) in its upper part.
